(19) United States
(12) Patent Application Publication
(10) Pub. No.: US 2020/0240527 A1
(43) Pub. Date: Jul. 30, 2020

(54) Valve and Method For Flow Control of Large Hard Particle Dry Materials

(71) Applicant: Plattco Corporation, Plattsburgh, NY (US)

(72) Inventors: Kevin Guay, Altona, NY (US); Alex Menard, Mooers, NY (US)

(21) Appl. No.: 16/753,644

(22) PCT Filed: Oct. 4, 2018
(86) PCT No.: PCT/US18/54369

§ 371 Date: Apr. 3, 2020

Related U.S. Application Data
(60) Provisional application No. 62/568,523, filed on Oct. 5, 2017.

(51) Int. Cl. F16K 3/02

(52) U.S. Cl. CPC F16K 3/0209; F16K 3/0263; F16K 3/0254

(57) ABSTRACT

A valve and method for flow control of dry materials comprising large hard particles. Providing clearance at the valve seat of at least slightly greater than the nominal diameter of the hard particles prevents capture of the hard particles between closing parts of the valve, which can damage the valve due to the hardness of the particle material. Clearance space as defined unexpectedly does not allow the particles to pass through when the valve closure member is positioned across the valve seat in a closed position.

### RELATED APPLICATION DATA

This application claims the benefit of priority of U.S. Provisional Patent Application Ser. No. 62/568,523, filed Oct. 5, 2017, and titled “Valve for Flow Control of Large Hard Particle Dry Maters”, which is incorporated by reference herein in its entirety.

### FIELD OF THE INVENTION

Embodiments disclosed herein relate to dry materials flow control valves and more particularly to valves and methods for flow control of large hard particle dry materials.

### BACKGROUND

Valves for control of dry materials are well-known in the art, and come in many different configurations with different valve mechanisms such as gates, flaps or disks. Valves with such mechanisms have a long history of use in flow control for dry materials or fine particle abrasives, such as ash or dry cement. However, conventional valve designs have been found to be inadequate for controlling flow of very hard dry materials with relatively larger particle or sphere size. New approaches to dry materials valve design are thus required for handling such materials.

### SUMMARY OF THE DISCLOSURE

In one disclosed example, a valve for controlling the flow of dry materials with large particle size includes a valve body defining an entrance and exit providing a path through the valve body. A valve seat is defined around an interior portion of the entrance. A valve closure member moves between an open position away from the valve seat and closed position across the valve seat. The valve seat and closure member define a clearance therebetween of equal to or greater than the particle diameter. The defined clearance may fall in the range of one times the particle diameter up to about two and one-half times the particle diameter. In some embodiments, the clearance will be about two times the particle diameter.

The valve closure member may, in one example, be a slide gate configured to move across the valve seat with a linearly translating motion. Guide rails may support the closure member during motion. The guide rails may be positioned to define a clearance between each rail and a side wall of the valve body substantially the same as the valve seat/closure member clearance. The guide rails may be supported on posts extending from the valve body side wall.

Valve seat clearance may be adjustable by providing a shim to raise or lower the valve closure member at its point of connection to an actuation means. Support posts for the guide rails further may be adjusted by mounting on side plates bolted to the outside of the valve body and extending through oval openings into the inside of the valve body. Screw adjustment means may be provided to vertically adjust the position of the side plates.

Actuation means for moving the valve closure member may include hydraulic cylinders, pneumatic cylinders, electric motors or solenoids. Limit switches may be provided to control the extent of motion of the actuation means.

In one implementation, the present disclosure is directed to a dry materials valve for controlling flow of hard particles, the hard particles having a diameter. The valve includes a valve body defining a valve seat and a closure member selectively positionable across the valve seat in a closed position to define a clearance space between the valve seat and the closure member in the closed position, wherein the clearance space is greater than the hard particle diameter.

In another implementation, the present disclosure is directed to a dry materials valve for controlling flow of hard particles, the hard particles having a diameter. The valve includes a valve body defining a particle entrance and a particle exit with an internal valve seat therebetween, the valve body being configured to provide for vertically downward particle flow from the entrance to the exit and across the valve seat; a valve gate configured to move in a horizontal direction, positionable across the valve seat in a closed position to define a clearance space between the valve seat and the valve gate in the closed position, the clearance space being greater than the hard particle diameter; support members attached to valve body side walls to support and guide movement of the valve gate horizontally between the closed position and an open position, the support members being spaced from the valve body side walls by at least the clearance space; and an actuator cooperating with the valve gate to selectively move the valve gate between the open and closed positions.

In yet another implementation, the present disclosure is directed to a method for controlling flow of dry materials comprising hard particles. The method includes directing a flow of hard particles having a diameter through a valve seat, selectively opening and closing the valve seat with a closure member; and spacing the closure member from the valve seat by a clearance space greater than the hard particle diameter.

### BRIEF DESCRIPTION OF THE DRAWINGS

For the purpose of illustrating the invention, the drawings show aspects of one or more embodiments of the invention. However, it should be understood that the present invention is not limited to the precise arrangements and instrumentalities shown in the drawings, wherein:

FIG. 1 is a perspective view of a slide gate valve according to embodiments disclosed herein.

FIG. 2 is a cross-sectional view as viewed through section A-A of FIG. 1.

FIG. 3 is a cross-sectional view as viewed through section B-B of FIG. 1

FIG. 4 is a partial detail view at detail area D as shown in FIG. 2.

FIG. 5 is a partial side view at section C-C in FIG. 3.

### DETAILED DESCRIPTION

In conventional valves for dry materials, and in particular abrasive dry materials, the clearance between the valve seat and valve closure member is typically designed to be as low as possible, in most cases preferably as close to zero as possible Eliminating clearance at the valve seat in an abrasive dry material valve is generally considered to be critical because any leakage of the dry material across the valve seat can cause erosion, a process which only accelerates as more and more abrasive particles are forced through the eroded valve seat. Thus, conventional design for dry and abrasive materials control valves dictates zero clearances and designs that will maintain zero clearances as closely as possible over a useful life of the valve.

However, contrary to generally accepted design principles for valves for flow control in dry materials systems, the present Applicant discovered that when using slide gate valves to control the flow of dry materials comprising large hard particles, such as hard ceramic balls with relatively large diameters, valves made according to conventional designs were unsatisfactory and had high failure rates. Without intending to be bound by theory, it is believed that the large hard particles were at times “captured” between a leading edge of the valve closure member and valve seat upon closure of the valve. Due to the hardness of the particles, combined with their size, a particle caught in this position would jam between the leading edge of the closure member and valve seat, damaging the valve; in some cases immediately rendering it inoperable. The damage can be amplified in applications requiring frequent or fast cycling wherein the valve is closed repeatedly while being subjected to particle flow (e.g., opening/closing multiple times per minute). The present Applicant discovered that damage to the valve could be alleviated by increasing the clearance between the valve seat to a size larger than the particle diameter, which is believed to avoid the capture of particles between the valve closure member leading edge and valve seat upon closure. Even with a large clearance space as described herein, particle flow is stopped abruptly as particles pile up quickly on the closure member, even when rapidly cycled, rather than falling through the clearance space as might be expected. Embodiments described herein thus employ this unexpectedly beneficial clearance space feature.

Embodiments described herein may be useful for controlling flow in any particles of relatively large size and high hardness as compared to the valve materials. Examples of such particles include ceramic balls as mentioned, which may be used, for example, as heat carriers in waste reforming processes among other uses. Iron ore pellets are examples of large particles for which embodiments disclosed herein may be useful for flow control. “Large particle diameter” as used herein is generally considered to be nominal diameters of about one-quarter (0.25) inch (about 6.35 mm) and larger. It is to be understood that actual particle size will in practice have a tolerance extending above and below stated nominal particle size. It is anticipated that most typically for use of embodiments as disclosed herein particle size will be in the range of about one-quarter (0.25) to about three-quarter (0.75) inch (about 6.35-19.05 mm), or, more specifically, about three-eighths (0.375) inch to about one-half (0.5) inch (about 9.53-12.7 mm). Substantially uniform particle diameter also may contribute to valve closure effectiveness. Particle size as used herein refers to a nominal particle size. It is to be understood that actual particle size will in practice have a tolerance extending above and below stated nominal particle size, the tolerance range varying based on quality control practices in particle formation. Variations in clearance space due to particle size tolerance range can be taken into account by persons of ordinary skill in the art based on the teachings herein. Disclosed designs have also been found to be useful for controlling flow of such particles at highly elevated temperatures such as experienced in waste reforming processes, for example in the range of about 700-1900° F.

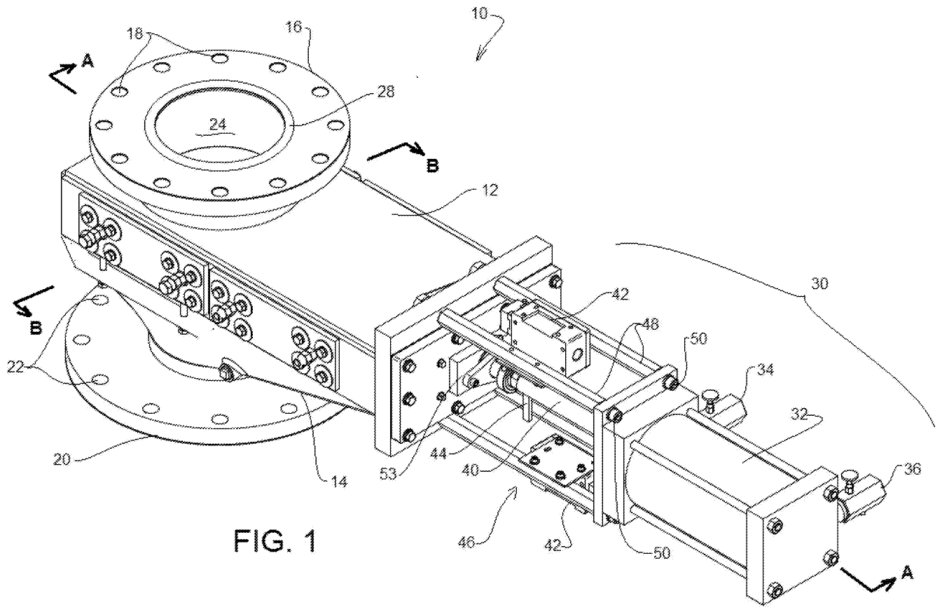

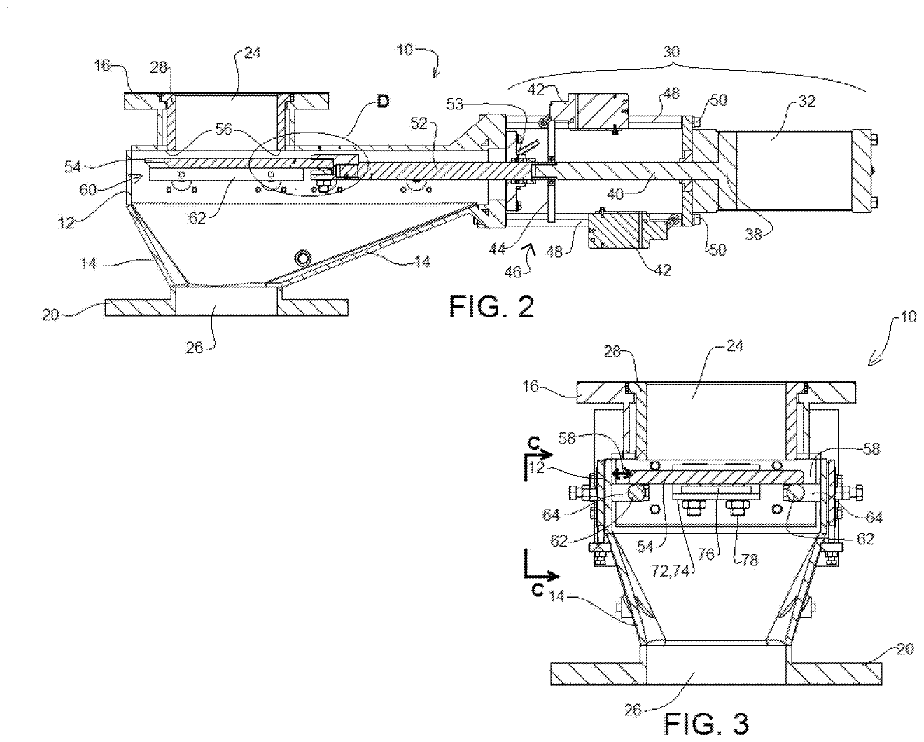

One example, configured as a slide gate valve employing the unexpected design features, is shown in FIGS. 1-5. As shown therein, valve 10 includes valve body 12 having lower sloped walls 14. Entrance flange 16 provides bolt holes 18 for attachment to an associated materials system and defines entrance 24. Exit flange 20 similarly provides flange bolt holes 22 for attachment to a downstream portion of a materials system and defines exit 26. To facilitate use with high temperature particles, high temperature sleeve 28 may be provided around the inside of entrance flange 16. Parts of the valve in general may be constructed from various, commercially available, high temperature/high strength/wear resistant alloys. High temperature sleeve 28 may be constructed from heat resistant stainless steel, for example, ASTM A297 Grade HT Stainless Steel.

Valve actuation means 30 may take many forms. In the illustrated example, actuation means 30 includes a double-acting hydraulic cylinder 32 having open port 34 and close port 36 to provide actuating fluid on opposite sides of piston 38. Two limit switches 42 may be provided, triggered by switch triggers 44, to control the extent of motion in both open and closed directions. Cylinder 32 may be mounted to valve body 12 by a support structure 46. In this example, support structure 46 comprises long coupling nuts 48 cooperating with bolts 50 to secure a mounting flange of cylinder 32 to a cooperating mounting flange on valve body 12. Piston rod 40 is attached to connecting rod 52, which passes into valve body 12 through linear sliding seal 53.

Within the valve body, connecting rod 52 is connected to valve closure member 54, which cooperates with valve seat 56 formed around valve entrance 24 by one or more of valve body 12, entrance flange 16 and high-temperature sleeve 28. In this example, valve closure member 54 comprises a plate member forming a slide gate. Other types of closure members may be employed consistent with overall valve design and principle of operation. Clearance (C) 58 is defined between valve seat 56 and closure member 54. Generally, clearance (C) will be at least slightly greater than the particle diameter. In various embodiments clearance (C) may be from slightly greater than the particle diameter to more than about two times the particle diameter. In some embodiments the clearance (C) employed will be approximately two times the particle diameter or two and one-half times particle diameter.

In one exemplary embodiment, flow of high temperature ceramic balls at a substantially uniform diameter one-half (0.5) inch (about 12.7 mm), is controlled using a slide gate type valve with a clearance (C) between the valve gate and valve seat of approximately one and one-sixteenth (1.0625) inches (about 26.99 mm), in other words, slightly greater than twice the particle diameter. In such an exemplary embodiment, the slope of sloped walls 14 may also be a factor in avoiding jamming of particles. Minimum slope of sloped walls 14 may be about 12°, with a slope in the range of about 20°-25°, or more specifically about 22° being selected based on specific particle flow characteristics. When using a slide gate valve embodiment such as the example shown in FIGS. 1-3, orientation of the valve in the system in which it is installed may impact performance of the valve. In such embodiments it may be preferred that the valve be mounted with vertically downward particle flow through the valve body and the valve closure member moving substantially horizontally across the flow below the valve seat.

Clearance (C) or an approximately equivalent minimum clearance is provided not only between valve seat 56 and closure member 54, but also around the sides of closure member 54 between the closure member and the walls of valve body 12. This side clearance is illustrated in FIG. 3 at arrow 58 and on the opposite side designated by 58 with no arrow. As mentioned above, it has been found that clearances smaller than the particle size are generally ineffective for particles of the type addressed by the disclosed valves. Guide assembly 60 supports the closure member while maintaining appropriate clearance on all sides. Guide assembly 60 includes support rails 62 mounted on support posts 64. In order to prevent capture of particles between support rails 62 and valve body 12, the distance between support rails 62 and valve body 12 also should be greater than the particle diameter. Further, the edges of closure member 54 do not extend over support rail 62 into the space between the support rail and valve body, even if the remaining clearance is larger than the particle diameter, because any portion of the closure member extending over the support rails may cause a large particle to be captured and cause damage.

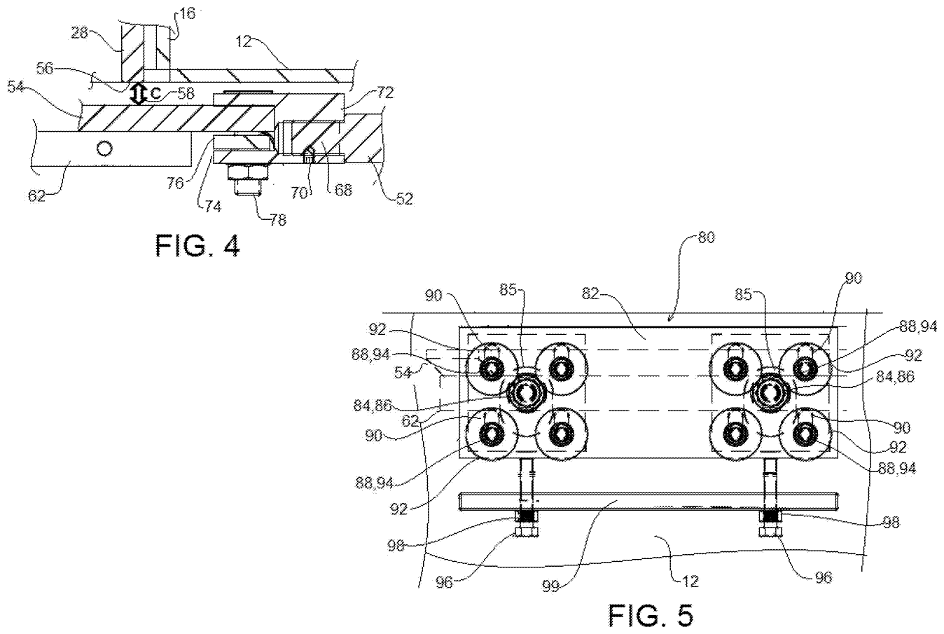

As best seen in the detail view of FIG. 4, closure member 54 is attached to connecting rod 52 by adjustable closure block 72 in order to provide ready adjustment of closure member position and clearance (C) for different sized particles. Connecting rod 52 has a threaded end 68 that is received in a complementarily threaded socket in closure block 72. Set screw 70 may be used to prevent rotation. Opposite connecting rod 52, closure block 72 defines clevis 74 to receive and secure closure member 54 and a clearance adjustment shim 76. Changing the height or thickness of clearance adjustment shim 76 allows the clearance (C) between the top of the closure member 54 and valve seat 56 to be adjusted. As shown in FIG. 4, clearance shim 76 is below closure member 54 to provide a lesser clearance. In one alternative example, shim 76 may be moved to above closure member 54, thus increasing clearance (C) by the width of shim 76. Intermediate adjustments may be made by different thicknesses of shims placed above and below closure member 54 within clevis 74. Nuts and bolts 78 are then used to secure closure member 54 and clearance shim 76 within clevis 74.

Adjustment of the closure member position upwardly or downwardly using adjustment shims 76 will also require a corresponding adjustment of the relative height position of support rails 62. This may be accomplished via side plate adjustment mechanism 80, best seen in FIG. 5. Side plate adjustment mechanism 80 includes side plates 82, which carry attachment/adjustment screws 84 for rail support posts 64. Screws 84 fix support posts 64 to side plates 82, but allow for inward and outward position adjustment by the threaded connection to side plates 82, secured with post lock nuts 86. Screws 84 extend through oval-shaped openings 85 in valve body 12 to allow vertical adjustment of the support post position. Side plate bolts 88, secured to valve body 12, extend through slotted holes 90 in side plates 82 to secure the side plates to valve body 12. Slotted holes 90 are covered by washers 92, and bolts 88 are secured with side plate nuts 94. When slide plate nuts 94 are loosened, the vertical position of side plates 82, and thus the vertical positions of support posts 64 secured thereto, may be adjusted. Side plate adjustment screws 96, with lock nuts 98, extend through threaded holes in side flanges 99 mounted to the side of valve body 12. Adjustment screws 96 bear against slots in the bottom edge of side plates 82, allowing for fine adjustment of the side plate vertical position to match the position of closure member 54 as set with adjustment shims 76 described above. Also represented in FIG. 5 by hidden lines are closure member 54 and guide rail 62, which are on the inside of valve body 12 in this view.

The following subparagraphs list additional and alternative embodiments and features, and alternative combinations thereof:
1. A dry materials valve for controlling flow of hard particles, the hard particles having a diameter, said valve comprising:
   a valve body defining a valve seat; and
   a closure member selectively positionable across the valve seat in a closed position to define a clearance space between the valve seat and the closure member in said closed position;
   wherein said clearance space is greater than the hard particle diameter.
2. The dry materials valve as in subparagraph 1 above, wherein said clearance space is up to two and one-half (2.5) times the hard particle diameter.
3. The dry materials valve as in subparagraph 2 above, wherein said clearance space is between about two (2) and two and one-half (2.5) times the hard particle diameter.
4. The dry materials valve as in subparagraph 1 or 2 above, wherein said hard particles have a diameter of at least about one-quarter (0.25) inches (6.35 mm).
5. The dry materials valve as in subparagraph 1, 2 or 3 above, wherein said valve seat and closure member are constructed of a material having a hardness less than the hardness of the hard particles.
6. The dry materials valve as in subparagraph 1, 2, 3, 4 or 5 above, wherein the hard particles are ceramic balls.
7. The dry materials as in subparagraph 6 above, wherein the ceramic balls are approximately one-half (0.5) inches (12.7 mm) in diameter and the clearance space is approximately one and one-sixteenth (1.0625) inches (26.99 mm).
8. The dry materials valve as in subparagraph 1, 2, 3, 4 or 5 above, wherein the hard particles are iron ore pellets.
9. The dry materials valve as in any of subparagraphs 1-8 above, wherein the valve body has side walls and the closure member is spaced from the side walls by at least said clearance space.
10. The dry materials valve as in subparagraph 9 above, wherein:
   the valve is a gate valve;
   the closure member is a valve gate;
   the valve gate rides on support members attached to the valve body side walls; and
   the support members are spaced from the side walls by at least said clearance space.
11. The dry materials valve as in any of subparagraphs 1-10 above, wherein the valve body below the closure member has side walls sloped at an angle of 12° or greater to direct particles to a valve outlet.
12. The dry materials valve as in any of subparagraphs 1-11 above, further comprising a valve actuator cooperating with the closure member to move the closure member along the support members between open and closed positions.
13. The dry materials valve as in subparagraph 12 above, wherein the actuator comprises a hydraulic piston.
14. A dry materials valve for controlling flow of hard particles, the hard particles having a diameter, said valve comprising:
   a valve body defining a particle entrance and a particle exit with an internal valve seat therebetween, the valve body being configured to provide for vertically downward particle flow from said entrance to said exit and across the valve seat;
   a valve gate configured to move in a horizontal direction, positionable across the valve seat in a closed position to define a clearance space between the valve seat and the valve gate in said closed position, said clearance space being greater than the hard particle diameter;
   support members attached to valve body side walls to support and guide movement of the valve gate horizontally between the closed position and an open position, said support members being spaced from the valve body side walls by at least said clearance space; and
   an actuator cooperating with the valve gate to selectively move the valve gate between the open and closed positions.
15. The dry materials valve as in subparagraph 14 above, wherein said clearance space is up to two and one-half (2.5) times the hard particle diameter.
16. The dry materials valve as in subparagraph 14 or 15 above, wherein the hard particles comprise ceramic balls having a particle diameter of approximately one-half (0.5) inches (12.7 mm) and wherein the clearance space is approximately one and one-sixteenth (1.0625) inches (26.99 mm).
17. A method for controlling flow of dry materials comprising hard particles, the method comprising:
   directing a flow of hard particles having a diameter through a valve seat;
   selectively opening and closing the valve seat with a closure member; and
   spacing the closure member from the valve seat by a clearance space greater than the hard particle diameter.
18. The method as in subparagraph 17 above, wherein:
   said directing comprises directing the flow of hard particles in a substantially vertical, downward direction through the valve seat; and
   said opening and closing comprises translating the closure member transverse to the flow of hard particles.
19. The method as in subparagraph 17 or 18 above, wherein said directing comprises directing a flow of hard particles having a substantially uniform diameter of at least about one-quarter (0.25) inch (6.35 mm) through the valve seat.
20. The method as in subparagraph 17, 18 or 19 above, wherein said flow of hard particles comprises particles having a hardness greater than the hardness of materials from which the valve seat and closure member are constructed.
21. The method as in subparagraph 17, 18, 19 or 20, above, wherein said spacing comprises spacing the closure member from the valve seat by clearance space of up to two and one-half (2.5) times the hard particle diameter.
22. The method as in subparagraph 21, wherein said clearance space is between about two (2) and two and one-half (2.5) times the hard particle diameter
23. The method as in any of subparagraphs 17-22 above, wherein said directing comprises directing a flow of ceramic balls through said valve seat.
24. The method as in subparagraph 23 above, wherein the ceramic balls are approximately one-half (0.5) inches (12.7 mm) in diameter and said spacing defines the clearance space as approximately one and one-sixteenth (1.0625) inches (26.99 mm).
25. The method as in any of subparagraph 17-22 above, wherein said directing comprises directing a flow of iron ore pellets through said valve seat.
26. The method as in any of subparagraphs 17-25 above, wherein said valve seat is disposed within a valve body including side walls and said spacing further comprises spacing the closure member from the side walls by at least said clearance space.
27. A method for controlling flow of dry materials comprising hard particles, comprising any of the steps in subparagraphs 17-26 above using a valve as in any of subparagraphs 1-16 above.

While principles of the present disclosure are exemplified above by reference to an example of a slide gate valve, the principles described herein are not limited in application specifically to slide gate valves. Other valve types for dry materials, such as flap valves, rotating disk valves, rotary valves or knife gate valves may be constructed according to the principles described herein.

Various modifications and additions can be made without departing from the spirit and scope of this invention. Features of each of the various embodiments described above may be combined with features of other described embodiments as appropriate in order to provide a multiplicity of feature combinations in associated new embodiments. Furthermore, while the foregoing describes a number of separate embodiments, what has been described herein is merely illustrative of the application of the principles of the present invention. Additionally, although particular methods herein may be illustrated and/or described as being performed in a specific order, the ordering is highly variable within ordinary skill to achieve aspects of the present disclosure. Accordingly, this description is meant to be taken only by way of example, and not to otherwise limit the scope of this invention.

Exemplary embodiments have been disclosed above and illustrated in the accompanying drawings. It will be understood by those skilled in the art that various changes, omissions and additions may be made to that which is specifically disclosed herein without departing from the spirit and scope of the present invention.

What is claimed is:

1. A dry materials valve for controlling flow of hard particles, the hard particles having a diameter, said valve comprising:
a valve body defining a valve seat; and
a closure member selectively positionable across the valve seat in a closed position to define a clearance space between the valve seat and the closure member in said closed position;
wherein said clearance space is greater than the hard particle diameter.

2. The dry materials valve of claim 1, wherein said clearance space is up to two and one-half (2.5) times the hard particle diameter.

3. The dry materials valve of claim 2, wherein said clearance space is between about two (2) and two and one-half (2.5) times the hard particle diameter.

4. The dry materials valve of claim 1, wherein said hard particles have a diameter of at least about one-quarter (0.25) inches (6.35 mm).

5. The dry materials valve of claim 1, wherein said valve seat and closure member are constructed of a material having a hardness less than the hardness of the hard particles.

6. The dry materials valve of claim 5, wherein the hard particles are ceramic balls.

7. The dry materials valve of claim 6, wherein the ceramic balls are approximately one-half (0.5) inches (12.7 mm) in diameter and the clearance space is approximately one and one-sixteenth (1.0625) inches (26.99 mm).

8. The dry materials valve of claim 5, wherein the hard particles are iron ore pellets.

9. The dry materials valve of claim 1, wherein the valve body has side walls and the closure member is spaced from the side walls by at least said clearance space.

10. The dry materials valve of claim 9, wherein:
the valve is a gate valve;
the closure member is a valve gate;
the valve gate rides on support members attached to the valve body side walls; and
the support members are spaced from the side walls by at least said clearance space.

11. The dry materials valve of claim 10, wherein the valve body below the valve gate has side walls sloped at an angle of 12° or greater to direct particles to a valve outlet.

12. The dry materials valve of claim 10, further comprising a valve actuator cooperating with the valve gate to move the valve gate along the support members between open and closed positions.

13. The dry materials valve of claim 12, wherein the actuator comprises a hydraulic piston.

14. A dry materials valve for controlling flow of hard particles, the hard particles having a diameter, said valve comprising:
a valve body defining a particle entrance and a particle exit with an internal valve seat therebetween, the valve body being configured to provide for vertically downward particle flow from said entrance to said exit and across the valve seat;
a valve gate configured to move in a horizontal direction, positionable across the valve seat in a closed position to define a clearance space between the valve seat and the valve gate in said closed position, said clearance space being greater than the hard particle diameter;
support members attached to valve body side walls to support and guide movement of the valve gate horizontally between the closed position and an open position, said support members being spaced from the valve body side walls by at least said clearance space; and
an actuator cooperating with the valve gate to selectively move the valve gate between the open and closed positions.

15. The dry materials valve of claim 14, wherein said clearance space is up to two and one-half (2.5) times the hard particle diameter.

16. The dry materials valve of claim 15, wherein the hard particles comprise ceramic balls having a particle diameter of approximately one-half (0.5) inches (12.7 mm) and wherein the clearance space is approximately one and one-sixteenth (1.0625) inches (26.99 mm).

17. A method for controlling flow of dry materials comprising hard particles, the method comprising:
directing a flow of hard particles having a diameter through a valve seat;
selectively opening and closing the valve seat with a closure member; and
spacing the closure member from the valve seat by a clearance space greater than the hard particle diameter.

18. The method of claim 17, wherein:
said directing comprises directing the flow of hard particles in a substantially vertical, downward direction through the valve seat; and
said opening and closing comprises translating the closure member transverse to the flow of hard particles.

19. The method of claim 17, wherein said directing comprises directing a flow of hard particles having a substantially uniform diameter of at least about one-quarter (0.25) inch (6.35 mm) through the valve seat.

20. The method of claim 17, wherein said flow of hard particles comprises particles having a hardness greater than the hardness of materials from which the valve seat and closure member are constructed.

21. The method of claim 17, wherein said spacing comprises spacing the closure member from the valve seat by clearance space of up to two and one-half (2.5) times the hard particle diameter.

22. The method of claim 21, wherein said clearance space is between about two (2) and two and one-half (2.5) times the hard particle diameter

23. The method of claim 17, wherein said directing comprises directing a flow of ceramic balls through said valve seat.

24. The method of claim 23, wherein the ceramic balls are approximately one-half (0.5) inches (12.7 mm) in diameter and said spacing defines the clearance space as approximately one and one-sixteenth (1.0625) inches (26.99 mm).

25. The method of claim 17, wherein said directing comprises directing a flow of iron ore pellets through said valve seat.

26. The method of claim 17, wherein said valve seat is disposed within a valve body including side walls and said spacing further comprises spacing the closure member from the side walls by at least said clearance space.
